(19) United States
(12) Patent Application Publication
(10) Pub. No.: US 2013/0332320 A1
(43) Pub. Date: Dec. 12, 2013

(54) VIRTUAL REALITY-BASED ENVIRONMENTS INCLUDING USER AVATARS

(71) Applicant: Nery J. Nieto, Miami, FL (US)

(72) Inventor: Nery J. Nieto, Miami, FL (US)

(21) Appl. No.: 13/490,016

(22) Filed: Jun. 6, 2012

(51) Int. Cl. G06Q 30/00

(52) U.S. Cl. 705/27.2

(57) ABSTRACT

A method for reviewing items of clothing over a communications network is provided. The method includes receiving an image of a consumer's face and measurements of the consumer's body, generating an avatar of the consumer based on the image and the measurements, generating a graphical environment including the avatar and virtual items of clothing, determining whether the surface of a virtual item of clothing fits around a predefined area of the surface of the avatar, wherein if it is determined that the virtual item of clothing fits, positioning the surface of the virtual item of clothing over the surface of the avatar and displaying the virtual item of clothing over the avatar for the consumer, and wherein if it is determined that the virtual item of clothing does not fit, displaying a message to the consumer indicating that the virtual item of clothing does not fit.

### CROSS-REFERENCE TO RELATED APPLICATIONS

Not Applicable.

### TECHNICAL FIELD

The technical field relates generally to e-commerce and, more specifically, to e-commerce systems operating over telecommunications networks.

### BACKGROUND

U.S. e-commerce sales totaled $165.4 billion in 2010, according to the U.S. Department of Commerce. The numbers also show that e-commerce is taking a bigger slice of the overall retail sales pie and is growing far faster than retail sales. There are some articles, however, that consumers prefer to purchase in person, instead of online. Clothing and accessories, for example, are items that users may prefer to purchase in physical stores, since the users may actually try on the items before purchase. Because it is difficult to tell whether an item of clothing will fit without trying it on, allowing a customer to change into an item of clothing before purchase allows the consumer to make better purchasing decisions. One of the problems with using the Internet to purchase clothing, for example, is that the Internet does not allow a consumer to try on an item of clothing before purchase. This leads to returns and increased expenses in shipping and re-stocking of goods.

Another problem with purchasing clothing online is that the consumer may not know his size and therefore may be required to guess his size. In addition, a consumer may only be provided with static images of the clothing, or images of the clothing or accessories on models selected by the retailer. In particular, there is no easy way for the user to see what an article of clothing will look like on the consumer's own body.

Yet another problem with shopping online is the lack of user interaction. One of the benefits of shopping at a physical store is that an attendant or personal shopper may aid the consumer in making shopping decisions, such as suggesting accessories, accompanying items or providing advice on what is trendy or popular. A conventional, static, e-commerce web site does not provide any of the aforementioned aid to a consumer.

Therefore, there exists a need to improve over the prior art, and, in particular, a more efficient way of harnessing the power of the online shopping experience to accommodate consumers shopping for clothing online.

### SUMMARY

This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a method for reviewing items of clothing over a communications network is provided. The method includes receiving an image of a consumer's face; receiving measurements of the consumer's body; generating an avatar of the consumer based on the image and the measurements, wherein the avatar comprises a surface correlating in size with the measurements; generating a graphical environment including the avatar of the consumer and virtual items of clothing; receiving a selection from the consumer of a virtual item of clothing comprising a surface that correlates in size to an actual item of clothing; determining whether the surface of the virtual item of clothing fits around a predefined area of the surface of the avatar; wherein if it is determined that the surface of the virtual item of clothing fits around the predefined area of the surface of the avatar, positioning the surface of the virtual item of clothing over the predefined area of the surface of the avatar; and displaying the virtual item of clothing over the predefined area of the surface of the avatar for viewing by the consumer; and wherein if it is determined that the surface of the virtual item of clothing does not fit around the predefined area of the surface of the avatar, displaying a message to the consumer indicating that the virtual item of clothing does not fit the avatar.

### BRIEF DESCRIPTION OF THE DRAWINGS

The accompanying drawings, which are incorporated in and constitute a part of this disclosure, illustrate various example embodiments. In the drawings:

FIG. 1 is a block diagram of an operating environment that supports virtual reality-based e-commerce environments including user avatars, according to an example embodiment;

FIG. 2 is an illustration of a virtual reality-based e-commerce web site including user avatars, according to an example embodiment;

FIG. 3 is a flow chart of a method for providing virtual reality-based e-commerce environments including user avatars, according to an example embodiment;

FIG. 4 is a flow chart of a method for generating an avatar, according to an example embodiment;

FIG. 5 is an illustration of a three dimensional representation of a surface, according to an example embodiment;

FIG. 6 is a block diagram of a system including a computing device, according to an example embodiment.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

The present invention improves over the prior art by allowing a consumer shopping online to determine whether an item of clothing will fit without physically trying it on before purchase, thereby allowing the consumer to make better purchasing decisions. One the resulting advantages is fewer returns from consumers and lowered expenses related to shipping and re-stocking of goods. The present invention further improves over the prior art by eliminating the need for a consumer to know his size, since the consumer's size is defined in an automated fashion. In addition, a consumer is provided with dynamic, three-dimensional images of the virtual clothing, thereby allowing better review of the clothing before purchase. Also, the present invention improves of the prior art by allowing a user to see what an article of clothing will look like on the consumer's own body before purchase. Further, the present invention improves over the prior art by providing a virtual attendant or virtual personal shopper that aids the consumer in making shopping decisions, such as suggesting accessories, accompanying items or providing advice on what is trendy or popular.

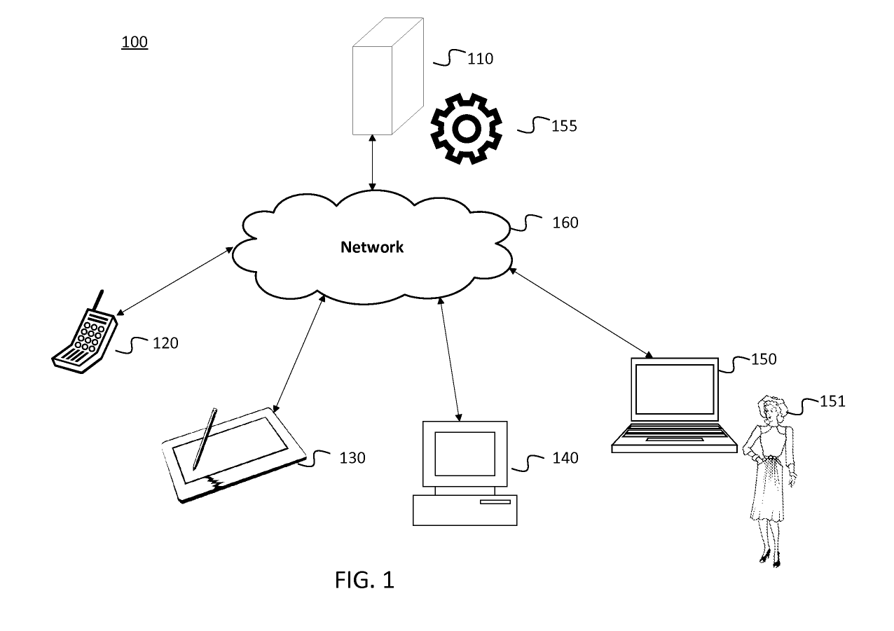

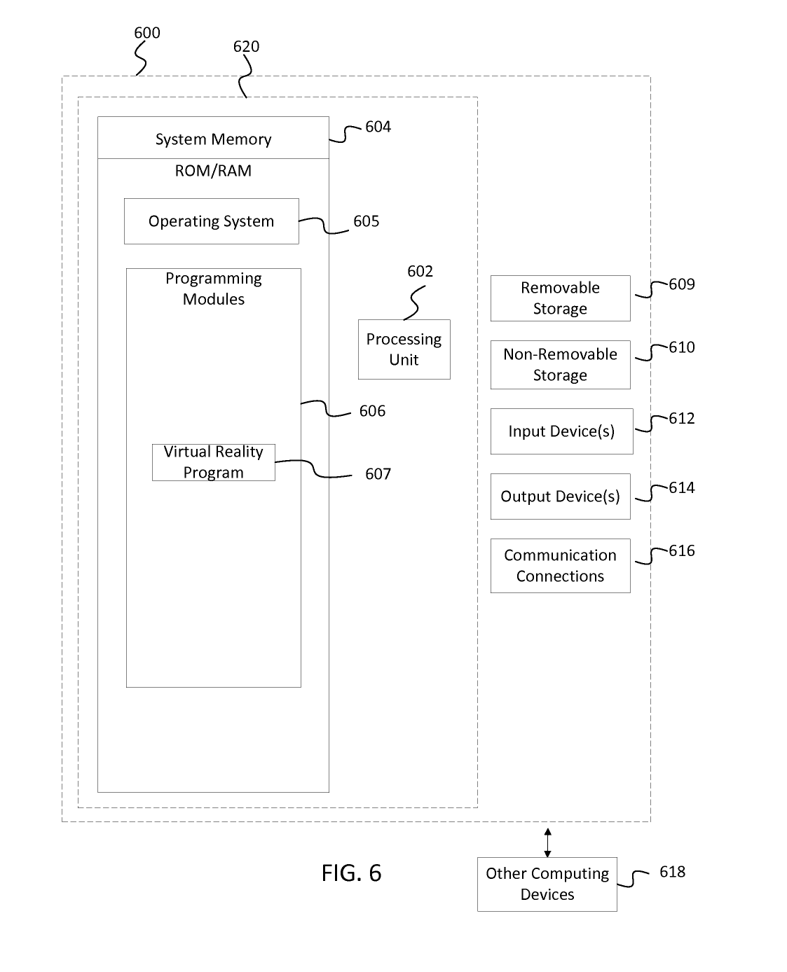

FIG. 1 shows a block diagram of an operating environment 100 that supports virtual reality-based e-commerce environments including user avatars, according to an example embodiment. The operating environment 100 may comprise multiple consumers or clients 120, 130, 140, 150 and an e-commerce server 110 communicating via a communications network 160. Each of the clients 120, 130, 140, 150 and server 110 may be connected either wirelessly or in a wired or fiber optic form to the communications network 160. Clients 120, 130, 140, 150 and e-commerce server 110 may each comprise a computing device 600, described below in greater detail with respect to FIG. 6. FIG. 1 shows that clients 120, 130, 140, 150 may comprise a desktop computer, laptop, tablet computer or smart phone, for example. Communications network 160 may be a packet switched network, such as the Internet, or any local area network, wide area network, enterprise private network or the like. FIG. 1 further shows a consumer 151 utilizing the laptop 150 to access e-commerce server 110.

Operating environment 100 may be used when multiple clients want to shop on e-commerce server 110 all at once or at different times. The e-commerce server 110 may provide an online shopping platform, as well as a virtual reality environment that supports avatars interacting with virtual goods, as defined in greater detail below. Server 110, which may be a web server, is the main operative element of the present invention, executing the steps that comprise the method of the present invention. It should be noted that although FIG. 1 shows only four clients 120, 130, 140, 150 and one server 110, the system of the present invention supports any number of clients and web servers connected via network 160.

Server 110 includes program logic 155 comprising computer source code, scripting language code or interpreted language code that is compiled to produce computer instructions that perform various functions of the present invention. In one embodiment of the present invention, the program logic is a scripting language. Program logic 155 may reside on a client, the server 110 or any combination of the two.

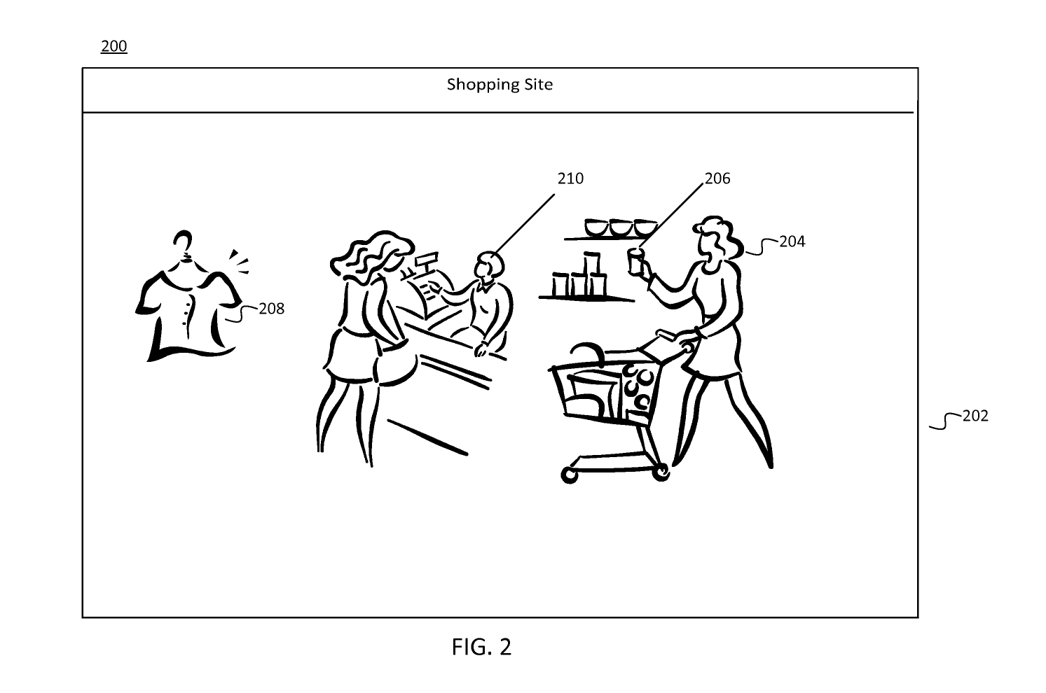

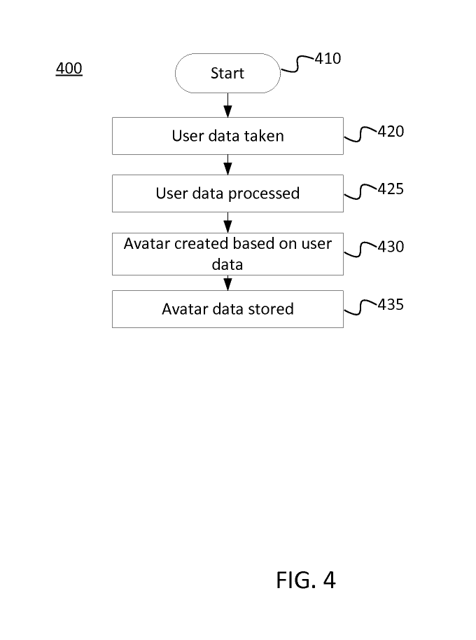

FIG. 2 is an illustration of a virtual reality-based e-commerce web site 200 including user avatars, according to an example embodiment. FIG. 2 shows a conventional web browser window 202 used to display the virtual reality-based e-commerce environments including user avatars, of the present invention. FIG. 2 shows that a consumer, such as consumer 151, may have and control an avatar 204 in the web browser window 202 displaying the virtual reality-based e-commerce environments. The process for creating an avatar is described more fully below with reference to method 400 in FIG. 4. Note that although a window is depicted in FIG. 2, the present invention supports other implementations in addition to windows.

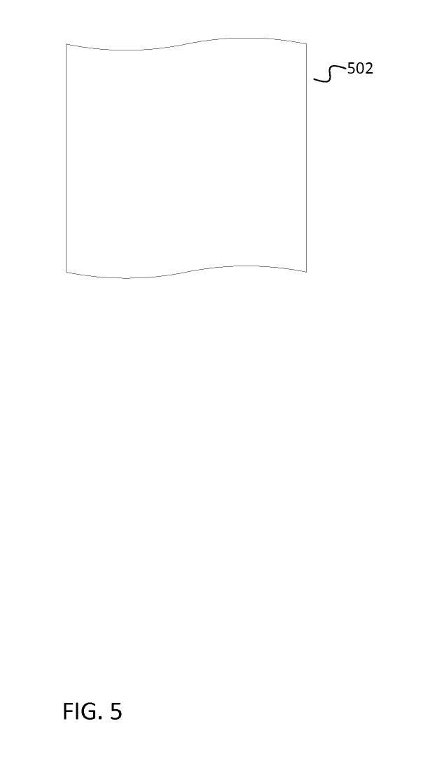

An avatar is the graphical representation of a user or the user's alter ego or character. An avatar may take either a three-dimensional form (see FIG. 5), as in games or virtual worlds, or a two-dimensional form as an icon in Internet forums and other online communities. An avatar 204 may comprise a three dimensional graphical representation of one or more surfaces, wherein the surface may depict varying colors and patterns and wherein the surface may have a thickness. Further, the surface of the avatar 204 may move and may have elasticity characteristics.

A consumer 151 may control her avatar 204, such as commanding her to walk around a virtual store, preview virtual goods and make purchases online. The avatar 204 may move, walk, act and talk like the consumer 151, which it represents. The avatar 204 may touch, hold, move, and otherwise inspect the virtual goods that are provided in the virtual shopping environment shown in the web site 200 of FIG. 2.

FIG. 2 further shows that web browser window 202, used to display the virtual reality-based e-commerce environments, may also display three dimensional graphical representations of products 206 (see FIG. 5) such as items of clothing 208. A virtual item of clothing 208 may comprise a three dimensional graphical representation of one or more surfaces, wherein the surface may depict varying colors and patterns and wherein the surface may have a thickness. Further, the surface of the virtual item of clothing 208 may move and may have elasticity characteristics. Note that the characteristics of the virtual item of clothing 208, whether it is size, elasticity, color, etc., correlates in size to an actual item of clothing for sale by a physical store. Products 206 may also include, shoes, jewelry, accessories and other items.

In one embodiment of the present invention, the web site 200 may allow the consumer 151 to determine whether the actual item of clothing (represented by the virtual item of clothing 208) fits the consumer 151 (represented by the avatar 204) by determining whether the surface of the virtual item of clothing 208 fits around a predefined area of the surface of the avatar 204. A predefined area of an avatar refers to that portion of the avatar on which the virtual item of clothing should be placed. A shirt, for example, is placed over the torso of an avatar. In a sense, the avatar 204 “tries on” the virtual item of clothing 208.

It is determined that the actual item of clothing fits the consumer 151 if the surface of the virtual item of clothing 208 mathematically or geometrically fits around the predefined area of the surface of the avatar 204. In this case, the web site 200 displays the virtual item of clothing 208 over, or worn by, the predefined area of the surface of the avatar 204 for viewing by the consumer 151. It is determined that the actual item of clothing does not fit the consumer 151 if the surface of the virtual item of clothing 208 mathematically or geometrically does not fit around the predefined area of the surface of the avatar 204. In this case, the web site 200 displays a message to the consumer 151 indicating that the virtual item of clothing 208 does not fit the avatar 204. The message may also be provided to the consumer 151 via audio and/or video.

In one embodiment of the present invention, the web site 200 may allow the consumer 151 to be attended by a virtual attendant or virtual personal shopper 210 that aids the consumer in making shopping decisions, such as suggesting accessories, accompanying items or providing advice on what is trendy or popular. The virtual attendant or virtual personal shopper 210 may also comprise an avatar and may be controlled by a physical person, by a computing device having artificial intelligence, or any combination of the two.

In one embodiment of the present invention, the web site 200 may allow the use of different backgrounds and environments that augment the user experience. For example, a snow environment or background may be used when winter clothing is being showcased, and a beach scene environment or background may be used when swimwear is showcased.

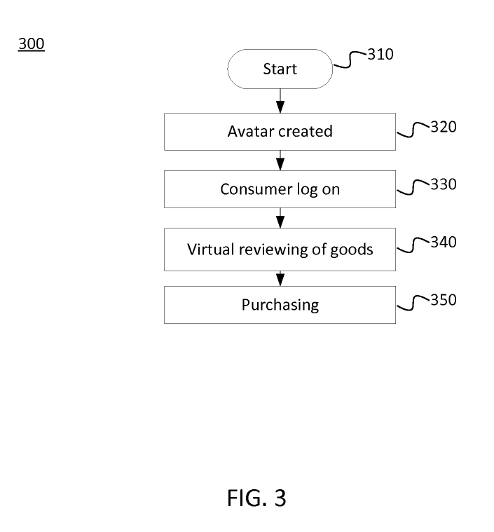

FIG. 3 is a flow chart of a method 300 for providing virtual reality-based e-commerce environments including user avatars, according to an example embodiment. Method 300 may be implemented by the various entities described in FIG. 1, such as server 110 and clients 120, 130, 140 and 150. FIG. 3 depicts the steps undertaken to provide virtual reality-based e-commerce environments including user avatars.

Method 300 may begin at starting block 310 and proceed to stage 320 wherein a user, such as consumer 151, creates an avatar. Stage 320 is described in greater detail below with reference to FIG. 4. Stage 320 may be performed by client computer 150, server 110 or any combination of the two. Next, in stage 330, the client 150 logs into the virtual shopping environment provided by server 110. In stage 340, the consumer 151 interacts with the client 150 to review virtual goods, such as virtual item of clothing 208. Also in stage 340, a virtual assistant 210 may assist the consumer 151 when reviewing virtual goods and making shopping decisions.

In stage 350, the consumer 151 makes a buying decision and proceeds to engage in a buying process, which may comprise providing payment information, such as credit card information, online. This stage may comprise interfacing with a payment gateway, which is an e-commerce Application Service Provider (ASP) service that authorizes payments for individuals, e-businesses, online retailers, or traditional brick and mortar businesses. A payment gateway is the equivalent of a physical point-of-sale terminal located in most retail outlets. Payment gateways encrypt sensitive information, such as credit card numbers, to ensure that information passes securely between the customer and the merchant. A payment gateway facilitates the transfer of information between a payment portal (such as a website) and the acquiring bank, quickly and securely. When a customer orders a product or service from a payment gateway enabled merchant, the payment gateway performs a variety of tasks to process the transaction. Payment gateways accept payment via the use of credit cards, charge cards, bank cards, gift cards, account cards, etc.

FIG. 4 is a flow chart of a method 400 for generating an avatar, according to an example embodiment. Method 400 may be implemented by one or more of the various entities described in FIG. 1, such as server 110 and clients 120, 130, 140 and 150. FIG. 4 depicts the steps undertaken to generate a user avatar.

Method 400 may begin at starting block 410 and proceed to stage 420 wherein data about the user, such as consumer 151, is taken. In one embodiment, the consumer 151 enters data about herself into a graphical user interface, such as answering questions about height, weight, hair color, skin color, build, frame, size of various body parts, clothing preferences, measurements, etc. In another embodiment, a camera, three dimensional scanner, LIDAR scanner, laser range finder, three dimensional imager, body scanner or other type of device is used to collect visual/measurement data about the consumer 151 and her body, similar to the data that may be entered by the consumer 151. In another embodiment, the data about consumer 151 is entered/collected using a combination of the two embodiments above.

In stage 425, the data collected in stage 420 is processed so as to place it in a form or format for creating a user avatar in stage 430, wherein the avatar may comprise a three dimensional graphical representation of one or more surfaces, wherein the surface may depict varying colors and patterns and wherein the surface may have a thickness. Further, the surface of the avatar may move and may have elasticity characteristics. In stage 435, the data about the avatar is stored in a record that is associated with a user record for consumer 151. In addition, electronic payment information may be stored in a record that is associated with a user record for consumer 151.

FIG. 5 is an illustration of a three dimensional representation of a surface 502, according to an example embodiment. In three dimensional computer graphics, three dimensional modeling is the process of developing a mathematical representation of any three-dimensional surface of object using software. The product is called a three dimensional model, such as surface 502 in FIG. 5. It can be displayed as a two-dimensional image through a process called three dimensional rendering or used in a computer simulation of physical phenomena. In this manner, avatars 204, 210 and virtual goods 206, 208 are graphically represented and rendered in window 202 of FIG. 2.

Three dimensional models represent a three dimensional object using a collection of points in three dimensional space, connected by various geometric entities such as triangles, lines, curved surfaces, etc. Being a collection of data (points and other information), three dimensional models can be created by hand, algorithmically (procedural modeling), or scanned.

FIG. 6 is a block diagram of a system including an example computing device 600 and other computing devices. Consistent with the embodiments described herein, the aforementioned actions performed by clients 120, 130, 140 and 150 and server 110 may be implemented in a computing device, such as the computing device 600 of FIG. 6. Any suitable combination of hardware, software, or firmware may be used to implement the computing device 600. The aforementioned system, device, and processors are examples and other systems, devices, and processors may comprise the aforementioned computing device. Furthermore, computing device 600 may comprise an operating environment for methods 300, 400 and 500 as described above. Methods 300, 400 and 500 may operate in other environments and are not limited to computing device 600.

With reference to FIG. 6, a system consistent with an embodiment of the invention may include a plurality of computing devices, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination or memory. System memory 604 may include operating system 605, one or more programming modules 606. Operating system 605, for example, may be suitable for controlling computing device 600's operation. In one embodiment, programming modules 606 may include, for example, a virtual reality program module 607. Furthermore, embodiments of the invention may be practiced in conjunction with a graphics library, other operating systems, or any other application program and is not limited to any particular application or system. This basic configuration is illustrated in FIG. 6 by those components within a dashed line 620.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer readable instructions, data structures, program modules, or other data. System memory 604, removable storage 609, and non-removable storage 610 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a camera, a touch input device, etc. Output device(s) 614 such as a display, speakers, a printer, etc. may also be included. The aforementioned devices are only examples, and other devices may be added or substituted.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 604, including operating system 605. While executing on processing unit 602, programming modules 606 (e.g. virtual reality program module 607) may perform processes including, for example, one or more of method 300's, 400's or method 500's stages as described above. The aforementioned processes are examples, and processing unit 602 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for reviewing items of clothing over a communications network, comprising:
receiving an image of a consumer's face;
receiving measurements of the consumer's body;
generating an avatar of the consumer based on the image and the measurements, wherein the avatar comprises a surface correlating in size with the measurements;
generating a graphical environment including the avatar of the consumer and virtual items of clothing;
receiving a selection from the consumer of a virtual item of clothing comprising a surface that correlates in size to an actual item of clothing;
determining whether the surface of the virtual item of clothing fits around a predefined area of the surface of the avatar;
wherein if it is determined that the surface of the virtual item of clothing fits around the predefined area of the surface of the avatar,
positioning the surface of the virtual item of clothing over the predefined area of the surface of the avatar; and
displaying the virtual item of clothing over the predefined area of the surface of the avatar for viewing by the consumer; and
wherein if it is determined that the surface of the virtual item of clothing does not fit around the predefined area of the surface of the avatar, displaying a message to the consumer indicating that the virtual item of clothing does not fit the avatar.

2. The method of claim 1, wherein the step of receiving an image of a consumer's face comprises receiving a two dimensional still image of the consumer's face from a camera.

3. The method of claim 1, wherein the step of receiving an image of a consumer's face comprises receiving a three dimensional image of the consumer's face from a three dimensional scanner.

4. The method of claim 1, wherein the step of receiving measurements of the consumer's body comprises receiving textual inputs from the consumer via a graphical user interface.

5. The method of claim 1, wherein the step of receiving measurements of the consumer's body comprises receiving a three dimensional image of the consumer's body from a three dimensional scanner.

6. The method of claim 1, wherein the step of generating an avatar of the consumer based on the image and the measurements, comprises generating a three dimensional model of the consumer based on the image and the measurements.

7. The method of claim 1, wherein the step of receiving a selection from the consumer of a virtual item of clothing comprises detecting a mouse click initiated by the consumer on a virtual item of clothing.

8. A computer-readable storage medium storing executable instructions, which, when executed by a computing device, cause the computing device to perform a method for reviewing items of clothing over a communications network, the method comprising:
receiving an image of a consumer's face;
receiving measurements of the consumer's body;
generating an avatar of the consumer based on the image and the measurements, wherein the avatar comprises a surface correlating in size with the measurements;
generating a graphical environment including the avatar of the consumer and virtual items of clothing;
receiving a selection from the consumer of a virtual item of clothing comprising a surface that correlates in size to an actual item of clothing;
determining whether the surface of the virtual item of clothing fits around a predefined area of the surface of the avatar;
wherein if it is determined that the surface of the virtual item of clothing fits around the predefined area of the surface of the avatar,
positioning the surface of the virtual item of clothing over the predefined area of the surface of the avatar; and
displaying the virtual item of clothing over the predefined area of the surface of the avatar for viewing by the consumer; and
wherein if it is determined that the surface of the virtual item of clothing does not fit around the predefined area of the surface of the avatar, displaying a message to the consumer indicating that the virtual item of clothing does not fit the avatar.

9. The computer-readable storage medium of claim 8, wherein the step of receiving an image of a consumer's face comprises receiving a two dimensional still image of the consumer's face from a camera.

10. The computer-readable storage medium of claim 8, wherein the step of receiving an image of a consumer's face comprises receiving a three dimensional image of the consumer's face from a three dimensional scanner.

11. The computer-readable storage medium of claim 8, wherein the step of receiving measurements of the consumer's body comprises receiving textual inputs from the consumer via a graphical user interface.

12. The computer-readable storage medium of claim 8, wherein the step of receiving measurements of the consumer's body comprises receiving a three dimensional image of the consumer's body from a three dimensional scanner.

13. The computer-readable storage medium of claim 8, wherein the step of generating an avatar of the consumer based on the image and the measurements, comprises generating a three dimensional model of the consumer based on the image and the measurements.

14. The computer-readable storage medium of claim 8, wherein the step of receiving a selection from the consumer of a virtual item of clothing comprises detecting a mouse click initiated by the consumer on a virtual item of clothing.

15. A computer system for providing a method for reviewing items of clothing over a communications network, the system comprising:
a memory storage;
a network connection device; and
a processing unit coupled to the memory storage, wherein the processing unit is operative for:
receiving an image of a consumer's face;
receiving measurements of the consumer's body;
generating an avatar of the consumer based on the image and the measurements, wherein the avatar comprises a surface correlating in size with the measurements;
generating a graphical environment including the avatar of the consumer and virtual items of clothing;
receiving a selection from the consumer of a virtual item of clothing comprising a surface that correlates in size to an actual item of clothing;
determining whether the surface of the virtual item of clothing fits around a predefined area of the surface of the avatar;
wherein if it is determined that the surface of the virtual item of clothing fits around the predefined area of the surface of the avatar,
positioning the surface of the virtual item of clothing over the predefined area of the surface of the avatar; and
displaying the virtual item of clothing over the predefined area of the surface of the avatar for viewing by the consumer; and
wherein if it is determined that the surface of the virtual item of clothing does not fit around the predefined area of the surface of the avatar,
displaying a message to the consumer indicating that the virtual item of clothing does not fit the avatar.

16. The computer system of claim 15, wherein the step of receiving an image of a consumer's face comprises receiving a two dimensional still image of the consumer's face from a camera.

17. The computer system of claim 15, wherein the step of receiving an image of a consumer's face comprises receiving a three dimensional image of the consumer's face from a three dimensional scanner.

18. The computer system of claim 15, wherein the step of receiving measurements of the consumer's body comprises receiving textual inputs from the consumer via a graphical user interface.
